(19) United States
(12) Patent Application Publication
(10) Pub. No.: US 2012/0059626 A1
(43) Pub. Date: Mar. 8, 2012

(54) WEIGHING CONTROL DEVICE AND METHOD THEREOF FOR ELECTRONIC BELT SCALE

(75) Inventors: Da Li, Jiangsu (CN); Fusheng He, Jiangsu (CN); Xingguo Zhang, Jiangsu (CN)

(73) Assignee: SAIMO ELECTRIC CO., LTD., Xuzhou, Jiangsu (CN)

(21) Appl. No.: 13/258,777

(22) PCT Filed: Mar. 16, 2010
(86) PCT No.: PCT/CN2010/071081

§ 371 Date: Nov. 21, 2011

(30) Foreign Application Priority Data
Apr. 22, 2009 (CN) 200910026387.7

(51) Int. Cl. G01G 19/00; G06F 15/00

(52) U.S. Cl. 702/173

(57) ABSTRACT

A weighing control device for an electronic belt scale comprises four weighing sensors (1), a suspended weighing loader (6), a displacement sensor (5) and an accumulator (4). The four weighing sensors(1) are respectively connected with the accumulator (4) which obtains a group of main accumulation values and two groups of auxiliary accumulation values based on the outputs of the four weighing sensors (1). The two groups of auxiliary accumulation values are compared with each other. If the difference between the two groups of auxiliary accumulation values is within the setting range, the main accumulation value is displayed. If the difference between the two groups of auxiliary accumulation values is beyond the setting range, the weighing sensor (1) in which a fault occurs is identified and the normal auxiliary accumulation value is displayed. A weighing control method for an electronic belt scale is also provided.

### FIELD OF THE INVENTION

The present invention relates to a weighing control device and method, and in particularly relates to the weighing control device and method for electronic belt scale which is used in belt conveyor for online monitoring of the continuous delivering materials.

### BACKGROUND OF THE INVENTION

At present, an electronic belt scale with full suspension loader construction used in belt conveyor for weighing continuous delivering materials is such a weighing control device, wherein a loader is provided with four weighing sensors, the weighing signals of the four weighing sensors are combined into one route of weighing signal for subsequent accumulating operation along with the velocity signal from the velocity sensor, and the results of the operations are displayed on an accumulator. In such a weighing control device for electronic belt scale, given that the four weighing signals are combined into one route of weighing signals before the accumulating operation along with the velocity signal, the entire belt scale will not provide accurate measurement when one of the sensors breaks down, and it is hard to be detected during the operation, thus this inaccurate measurement will cause losses during the delivery of materials.

### SUMMARY OF THE INVENTION

The present invention is intended to overcome the shortcomings in the prior art, and provide a weighing control device and method for electronic belt scale so that malfunction of certain weighing sensor can be detected by changing the combination mode and the electronic belt scale still can perform accurate measurements when certain weighing sensor is damaged.

To achieve the above object, the weighing control device in the invention comprises a full suspension weighing loader supported by four weighing sensors, displacement sensor and accumulator, wherein, the signal output terminals of the four weighing sensors are connected to the accumulator via four routes and the four routes of weighing signals are combined into three groups of signals through software programming in the accumulator, thus the weighing of weighing loader includes one group of full suspension type main accumulative amount and two groups of single lever type subsidiary accumulative amounts, and the accumulator consists of a computer or electronic weighing display control instrument.

In the three groups of weighing signals, one is the main accumulative amount from the combination of weighing sensors A, B, C and D, while the other two are the subsidiary accumulative amount from the combination of weighing sensors A and B and the subsidiary accumulative amount from the combination of weighing sensors C and D.

The weighing control method of the present invention, including:

a. The four routes of weighing signals received are combined into three groups of signals via the software module of the processor, wherein one group is the signal of full suspension type main accumulative amount from A1, B1, C1 and D1 while the other two are signals of single lever type subsidiary accumulative amount from A1 and B1 or C1 and D1.

b. Detect the subsidiary accumulative amount signals from the combination of weighing sensors A and B and from the combination of weighing sensors C and D;

c. Real-time online comparison;

If the difference between the value of the above two groups of subsidiary accumulative amount is small and within the setting range, the displayed value on the display is the main accumulative amount resulting from the combination of weighing sensors A, B, C and D;

If the difference between the value of the above two groups of subsidiary accumulative amount is big and beyond the setting range, the output signals from the two groups of weighing sensors are compared separately to identify the broken-down weighing sensor;

d. Alarm is sounded to the subsidiary integrator where the subsidiary accumulative amount resulting from the combination of weighing sensors A and B or C and D is beyond the setting range, while a group of subsidiary accumulative amount resulting from failure-free combination of the weighing sensors A and B or C and D is selected to replace the main accumulative amount for display, so that the belt scale remains reliable in weighing when one weighing sensor breaks down.

Beneficial Effect

In the present invention, three groups of accumulative amount values are obtained through calculation in three different combinations of the outputs from four weighing sensors, and the accumulator performs real-time online comparison for two groups of the accumulative amount values through program, judges if one of the weighing sensors breaks down, then give an alarm and displays one group of accumulative amount values of the weighing sensors with normal output, therefore the electronic belt scale remains reliable in weighing even when one weighing sensor breaks down. Now, no stop is required and the equipment can continue to run reliably, then the broken-down sensor is replaced after the entire operation ends and the machine stops, thus avoiding the various losses resulting from the re-calibration of the belt scale due to the replacement of sensor, and solve the problem of inaccurate measurement, which is hard to detect, due to anomaly of the sensor. This improves the reliability and measurement accuracy of the belt scale and is suitable for online accurate and reliable weighing measurement of continuous delivering materials in belt conveyer. This provides compact and logical construction, high reliability, accurate measurement, easy maintenance, long service life and extensive practicability.

### DESCRIPTION OF THE DRAWINGS

FIG. 1 is a schematic view for the theory and construction of the present invention;

FIG. 2 is a schematic view for the construction of the weighing control device in the present invention;

FIG. 3 is a flow chart for signal comparison program in the present invention;

In the drawings, 1- weighing sensor, 2- signal converter, 3- subsidiary integrator, 4-accumulator, 5- displacement sensor, 6- weighing loader.

### DETAILED DESCRIPTION OF THE EMBODIMENTS

An embodiment of the invention is further described below with reference to the attached drawings:

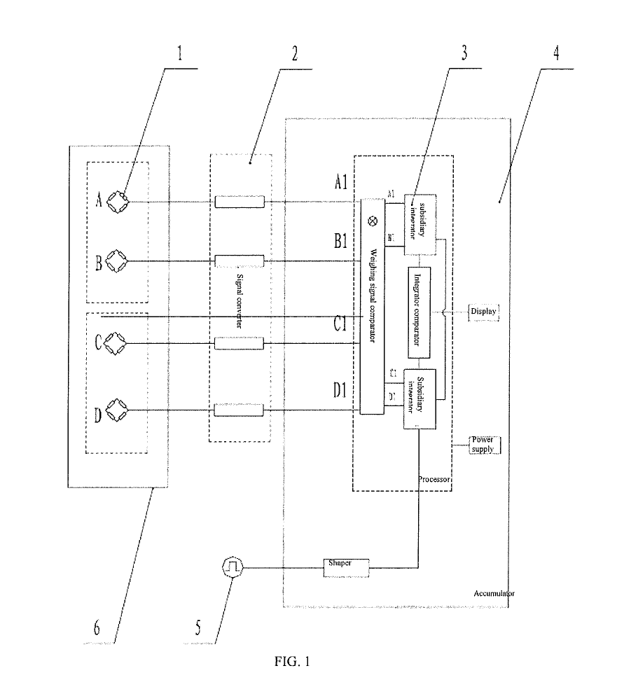

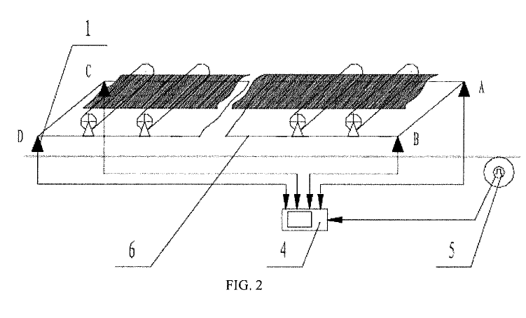

As shown in FIGS. 1 and 2, the weighing control device in the present invention is composed predominantly of four weighing sensors (1) A, B, C and D, a full suspension weighing loader (6) supported by the four weighing sensors (1), a displacement sensor (5) and accumulator (4). When the weighing sensors (1) are analog signal sensors, the weighing sensors (1) are connected with signal converter (2) as shown in FIG. 1; and when the weighing sensors (1) are digital signal sensors, signal converter (2) is not required. The accumulator (4) mainly comprises processor, shaper, storage, display and power supply, wherein the signal converter (2) is a 24 bit A/D converting circuit AD7710, the processor is a 32 bit CPU integrated circuit S3C44BOX, the storage is integrated circuit 39VF160, the displacement signal shaper is integrated circuit 393, the display is of 640×320 dot matrix and the power supply is 220V AC. The processor comprises weighing signal comparator, 2 subsidiary integrators (3) connected thereto, and integrator comparator connected between the two subsidiary integrators (3). The signal output terminals of the four weighing sensors (1) are connected with the accumulator (4) separately in four routes. The four routes of weighing signals are combined into three groups of signals by software programming in the accumulator (4), wherein one group is the main accumulative amount resulting from the combined weighing sensors (1) A, B, C and D, while the other two are the subsidiary accumulative amount resulting from combined weighing sensors (1) A and B and the subsidiary accumulative amount resulting from combined weighing sensors (1) C and D, forming the weighing toward the weighing loader (6) with one group of full suspension type main accumulative amount and two groups of single lever type subsidiary accumulative amount. Compare the output signal of weighing loader 6 via accumulator. Perform real-time online comparison, judgment and control. The accumulator 4 immediately judges, controls and displays the normal accumulative amount when a group of signals becomes abnormal. The accumulator (4) can also adopt computer to simplify construction and exercise control over the weighing loader (6) by software programming.

A weighing control method in the present invention, wherein: connect the accumulator (4) which is composed of a computer or an electronic weighing display control instrument by using the four weighing sensors (1) arranged on the full suspension weighing loader (6) and a displacement sensor (5) arranged on the electronic belt scale, perform calculation in three different combinations for independent outputs from the four weighing sensors (1) through program control of the processor software module to obtain three computed results of different combinations; the weighing loader (6) on the electronic belt scale form one full suspension type weighing loader and two single lever type weighing loaders (6) through the different combinations of weighing sensors (1) , thereby resulting in three groups of accumulative amount values, wherein two groups from the two single lever type weighing loaders are compared in real-time and online. If the difference of the two groups of accumulative amount values are small and within the setting range, the weighing sensors are considered to be free of fault. The accumulator (4) displays a main accumulative amount with the construction of full suspension type weighing loader (6) composed of weighing sensors A, B, C and D; and if the difference of the two groups of accumulative amount values are big and beyond the setting range, the outputs from weighing sensors (1) of each group are further compared separately to judge if a certain weighing sensor (1) breaks down. The accumulator will display one group of subsidiary accumulative amount from the weighing sensors (1) which have normal output and a construction of single lever type weighing loader, (4), so that the electronic belt scale remains reliable in weighing even if one weighing sensor breaks down.

The outputs from weighing sensors (1) A, B, C and D form four routes of independent signals A1, B1, C1 and D1 via signal converter (2) (which is not required when the output signals from weighing sensors (1) A, B, C and D are digital signals) and the signals enter the processor for signal processing. The velocity signal from the displacement sensor (5) becomes digital velocity signal via the shaper which then enters the processor for signal processing. In the software modules of the processor, two subsidiary integrators(3) produce two subsidiary accumulative amounts of the electronic belt scale by integrating the weighing signals and digital velocity signals from the two groups of A1, B1 and C1, D1 respectively; and the integrator comparator of the software modules in the processor makes real-time comparison, judgment and control of the subsidiary accumulative amounts in the two subsidiary integrators (3). In normal operating condition, the structural accumulative amount with construction of the full suspension weighing loader (6) composed of four weighing sensors (1) serves as the main accumulative amount of the electronic belt scale. When the difference between them is within the required setting range, the processor sends the main accumulative amount to the display for presentation; when the difference between them is beyond the required setting range, the weighing signal comparator in the software module of the processor compares the two groups of weighing signals A1, B1 and C1, D1 from the two subsidiary integrators (3) separately, and when the difference between A1 and B1 signals is within the required setting range, the processor sends the accumulative amount from the subsidiary integrators (3) of A1 and B1 to the display for presentation and sounds alarm to the digital weighing signals in the subsidiary integrators (3) of C1 and D1. In the above cases, if the difference between A1 and B1 signals is beyond the required setting range, the processor sends the accumulative amount from the subsidiary integrators (3) of C1 and D1 to the display for presentation, and sounds alarm to digital weighing signals in the subsidiary integrators (3) of A1 and B1. Compared with the above cases, the electronic belt scale can obtain three relevant combination types without any change in the construction other than the change in the function of the hinged point between the weighing sensor (1) and weighing loader (6). In the full suspension type weighing loader (6) of Type I, the hinged points between the four weighing sensors (1) A, B, C, D and the weighing loader (6) all serve as the force-metering points, and now the electronic belt scale becomes a full suspension type weighing loader (6) through combination and transformation; in the single lever type weighing loader (6) of Type II, the hinged points between weighing sensors (1) A, B and the weighing loader (6) serve only as supporting points while the hinged points between weighing sensors (1) C, D and the weighing loader (6) still serve as the force-metering points, and now the electronic belt scale becomes a single lever type weighing loader (6) through combination and transformation with the hinged points between weighing sensors (1) A, B and the weighing loader (6) being used as supporting points and the hinged points between weighing sensors (1) C, D and the weighing loader (6) being used as the force-metering points; and in the single lever type weighing loader (6) of Type III, the hinged points between weighing sensors (1) A, B and the weighing loader (6) serve as force-metering points while the hinged points between weighing sensors (1) C, D and the weighing loader (6) serve as supporting points, and now the electronic belt scale becomes a single lever type weighing loader (6) through combination and transformation with the hinged points between weighing sensors (1) A, B and the weighing loader (6) being used as force-metering points and the hinged points between weighing sensors (1) C, D and the weighing loader (6) being used as the supporting points. In a system fault, as long as one of the two subsidiary integrators (3) is normal, the electronic belt scale system will continue to normally run, and now the electronic belt scale becomes a single lever type weighing loader (6) through combination and transformation so that the weighing system has a continuous measurement and will not shut down, and no replacement of weighing sensor will take place till a normal shutdown, thus the losses resulting from the re-calibration of the belt scale required after the replacement of sensor and from inaccurate measurements is avoided, the difficulty that anomaly of a sensor during the delivery causes inaccurate measurement, which is hard to detect, is addressed, thus the reliability of the electronic belt scale system is improved.

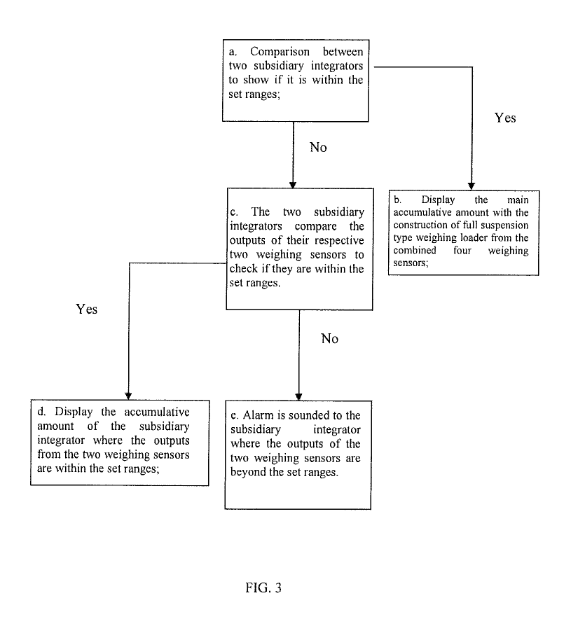

FIG. 3 shows a process flow for signal comparison:

a. Comparison between two subsidiary integrators (3) to identify whether it is within the setting range;

b. Yes. Display the main accumulative amount with the construction of full suspension type weighing loader (6) from the combined four weighing sensors (1);

c. No. The two subsidiary integrators (3) compare the outputs of the two weighing sensors thereof respectively to check if they are within the setting range;

d. Yes. Display the accumulative amount of the subsidiary integrator from the two weighing sensors (1) with the outputs within the setting range;

e. No. Sound alarm to the subsidiary integrators when the outputs of the two weighing sensors (1) are beyond the setting range.

1. A weighing control device for electronic belt scale, which comprises a full suspension weighing loader (6) supported by four weighing sensors (1), displacement sensor (5) and accumulator (4), characterized in that the signal output terminals of the four weighing sensors are connected to the accumulator (4) via four routes and the four routes of weighing signals are combined into three groups of signals through programming in the accumulator (4), providing weighing of the weighing loader (6) with one group of full suspension type main accumulative amount and two groups of single lever type subsidiary accumulative amount, and the accumulator (4) consists of a computer or electronic weighing display control instrument.

2. The weighing control device for electronic belt scale according to claim 1, characterized in that, for the three groups of weighing signals, one is the main accumulative amount from the combination of weighing sensors (1) A, B, C and D while the other two are the subsidiary accumulative amount from the combination of weighing sensors (1) A and B and the subsidiary accumulative amount from the combination of weighing sensors (1) C and D.

3. A weighing control method for the electronic belt scale for the device according to in claim 1, characterized in that:
a. The four routes of weighing signals received are combined into three groups of signals via the software module of the processor, wherein one group is the signal of full suspension type main accumulative amount from A1, B1, C1 and D1, while the other two are signals of single lever type subsidiary accumulative amount from A1, B1 or C1, D1 b. Detect the subsidiary accumulative amount signal produced by the combination of weighing sensors (1) A and B and by the combination of weighing sensors (1) C and D;
c. Real-time online comparison;
If the difference between compared values from the above two groups of subsidiary accumulative amount is small and within the setting range, the value on the display is the main accumulative amount signal resulting from the combination of weighing sensors (1) A, B, C and D;
If the difference between compared values from the above two groups of subsidiary accumulative amount is big and beyond the setting range, the output signals from the two groups of weighing sensors are compared separately to identify the broken-down weighing sensor;
d. Alarm is sounded to the subsidiary integrator where the subsidiary accumulative amount resulting from the combined A and B or C and D weighing sensors (1) is beyond the setting range, while a group of subsidiary accumulative amount from the combined A and B or C and D weighing sensors (1), whichever is free of fault, is selected to replace the main accumulative amount for display so that the beltscale remains reliable in weighing when one weighing sensor (1) breaks down.
